(19) United States
(12) Patent Application Publication
(10) Pub. No.: US 2013/0127771 A1
(43) Pub. Date: May 23, 2013

(54) TOUCH SENSOR WITH SURFACE IRREGULARITIES

(71) Applicants: Carl Carley, Basingstoke (GB); David Brent Guard, Southhampton (GB)

(72) Inventors: Carl Carley, Basingstoke (GB); David Brent Guard, Southhampton (GB)

(21) Appl. No.: 13/329,929

(22) Filed: Dec. 19, 2011

Related U.S. Application Data
(60) Provisional application No. 61/563,007, filed on Nov. 22, 2011.

(51) Int. Cl. G06F 3/044

(52) U.S. Cl. 345/174

(57) ABSTRACT

In one embodiment, an apparatus includes a substrate having a first surface and a second surface opposite the first surface. At least a portion of the first surface includes a plurality of irregularities. The apparatus further includes a touch sensor disposed on the substrate. The touch sensor comprising drive or sense electrodes.

### RELATED APPLICATION

This application claims the benefit, under 35 U.S.C. §119(e), of U.S. Provisional Patent Application No. 61/563,007 filed 22 Nov. 2011.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIGS. 2A-2B illustrate two example mesh patterns of a touch-sensitive mesh layer.

FIGS. 3A-3B illustrate two example mechanical stacks.

FIG. 4 illustrates an example mobile telephone that incorporates a substrate with irregularities.

### DESCRIPTION OF EXAMPLE EMBODIMENTS

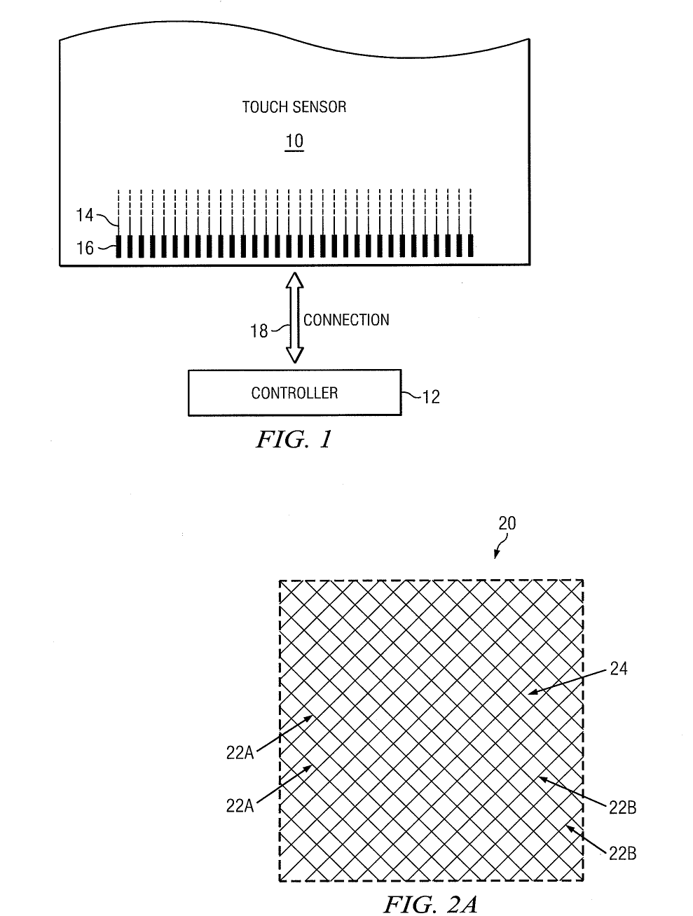

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs) or digital signal processors (DSPs)) of a device that includes touch sensor 10 and touch-sensor controller 12, which may respond to the touch or proximity input by initiating a function of the device (or an application running on the device) associated with it. Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

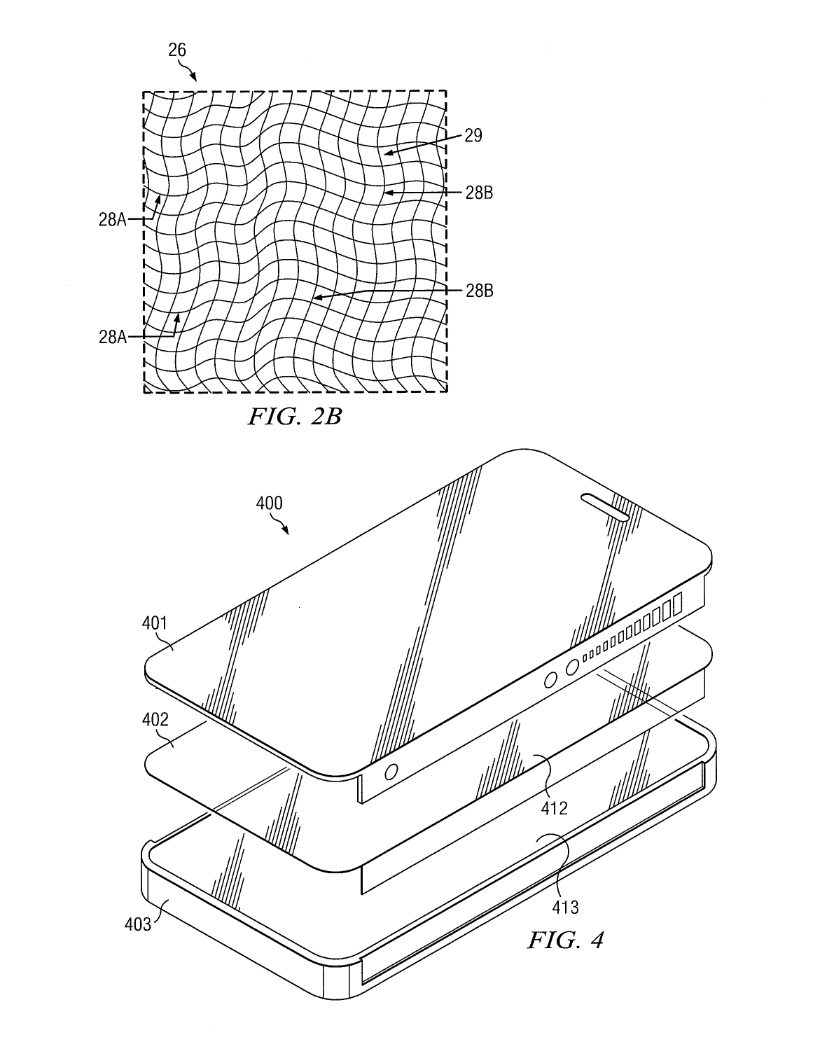

FIGS. 2A-2B illustrate two example mesh patterns of a touch-sensitive mesh layer. As discussed above, an electrode may be made of fine lines 22A-B of metal or other conductive material (e.g., copper, silver, or a copper- or silver-based material) and the lines 22A-B of conductive material may occupy the area of the electrode shape in a hatched, mesh, or other suitable pattern. In the example of FIG. 2A, an example mesh pattern 20 of a touch-sensitive mesh layer is formed from substantially straight lines 22A-B of conductive material. Mesh pattern 20 may be formed using two sets 22A-B of substantially parallel lines of conductive material. Mesh pattern 20 may be made up of an array of polygon-shaped mesh cells 24 formed from substantially orthogonal intersections between lines 22A with lines 22B of conductive material. As an example and not by way of limitation, first set 22A and second set 22B of conducting lines may be disposed such that a total line density is less than approximately 10% of a surface area. Thus, the contribution of the conductive lines to the reduction of transmission of light through mesh pattern 20 may be less than approximately 10%. In particular embodiments, the conductive lines may result in an attenuation of, for example, 3-10% of the transmission of light through mesh pattern 20.

In the example of FIG. 2B, mesh pattern 26 is formed from substantially non-linear conductive lines 28A-B. Non-linear line patterns 28A-B may be used to avoid long linear stretches of fine metal with a repeat frequency, reducing a probability of causing interference or moiré patterns. The non-linear pattern of the conductive lines 28A-B of mesh pattern 26 may disperse and hence reduce the visibility of reflections from conductive lines 28A-B when illuminated by incident light. As an example and not by way of limitation, each of conductive lines 28A-B of mesh pattern 26 may have a substantially sinusoidal shape. Mesh pattern 26 may be made up of an array of mesh cells 29 formed from non-orthogonal intersections between lines 26A with lines 26B of conductive material. Although this disclosure describes or illustrates particular mesh patterns, this disclosure contemplates any suitable mesh pattern formed using conductive lines with any suitable configuration.

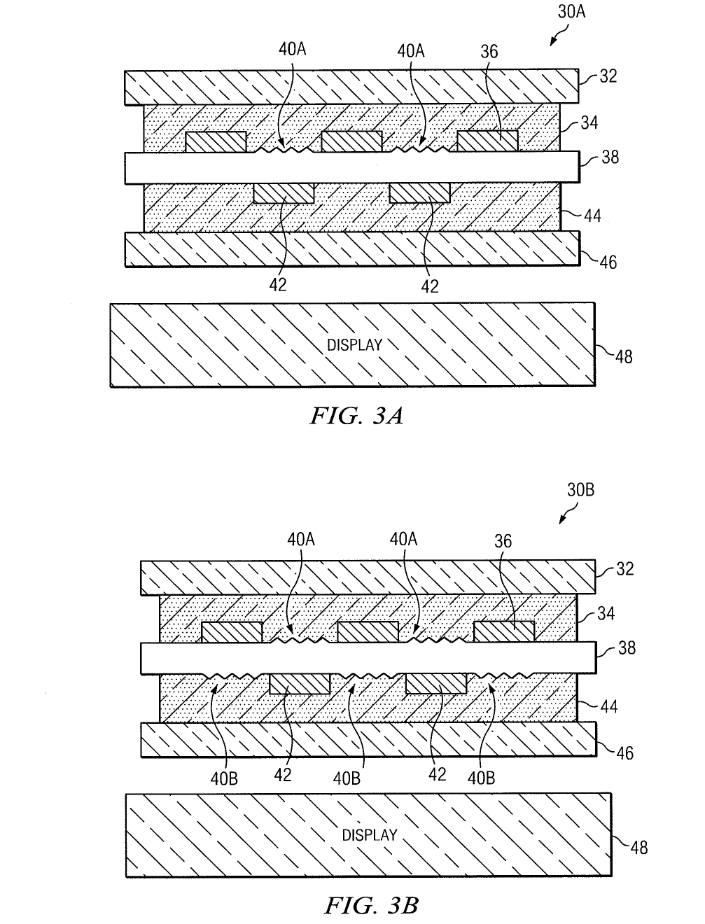

FIGS. 3A-3B illustrate two example mechanical stacks. In a particular embodiment, mechanical stacks 30A and 30B of FIGS. 3A and 3B include a cover panel 32, a first layer of OCA 34, sense electrodes 36 formed on one side of substrate 38, drive electrodes 42 formed on an opposite side of substrate 38, a second layer of OCA 44, a dielectric layer 46, and a display 48, examples of which are discussed above. In the example of FIG. 3A, substrate 38 includes one or more irregularities 40A on the top surface of substrate 38. In the example of FIG. 3B, substrate 38 includes one or more irregularities 40A on the top surface of substrate 38 and one or more irregularities 40B on a bottom side of substrate 38.

Irregularities 40 may include any irregularities configured to diffuse light. For example, when light enters a typical mechanical stack, it may be reflected back towards the cover panel of the mechanical stack by one or more surfaces of substrate 38. To the contrary, in particular embodiments, when light enters a mechanical stack with a substrate that includes one or more irregularities 40, instead of being reflected directly back towards the cover panel, the one or more irregularities 40 may diffuse the light, thereby reducing the reflection of that light back towards the cover panel.

Substrate 38 may include any number of irregularities 40, and irregularities 40 may have any pattern on substrate 38. In particular embodiments, irregularities 40 may only be formed on certain portions of a surface of substrate 38. As such, irregularities 40 may not be formed on an entire surface of substrate 38. In the example of FIG. 3A, irregularities 40A are formed on the top surface of substrate 38 in a pattern that is coincident with drive electrodes 42 on the bottom side of substrate 38. In such an example, irregularities 40A may diffuse light entering the mechanical stack through cover panel 32. In the example of FIG. 3B, irregularities 40A are formed on the top surface of substrate 38 in a pattern that is coincident with drive electrodes 42 on the bottom side of substrate 38, and irregularities 40B are formed on the bottom surface of substrate 38 in a pattern that is coincident with receive electrodes 36 on the top side of substrate. In such an example, irregularities 40A may diffuse light entering the mechanical stack through cover panel 32 and irregularities 40B may diffuse light transmitted into the mechanical stack by display 48. Furthermore, although FIG. 3B illustrates an example that includes both irregularities 40A and 40B, in particular embodiments, only irregularities 40B may be formed on substrate 38. As another example and not by way of limitation, irregularities 40 may be formed on substrate 38 only in-between drive electrodes 42 or sense electrodes 36. Therefore, if drive electrodes 42 or sense electrodes 36 include a conductive mesh pattern (such as is discussed above with regard to FIGS. 2A-2B), irregularities 40 may only be formed in-between the conductive mesh pattern of drive electrodes 42 or sense electrodes 36. In particular embodiments, irregularities 40 may be formed on substrate 38 in areas that include drive electrodes 42 or sense electrodes 36. Therefore, in order to form irregularities 40, a method may be used which does not interfere with (or compromise) drive electrodes 42 or sense electrodes 36. As an example and not by way of limitation, irregularities 40 may be formed prior to drive electrodes 42 or sense electrodes 36 being formed on substrate 38. In particular embodiments, irregularities 40 may be formed on an entire surface of substrate 38.

Irregularities 40 may be formed in any suitable manner. As an example and not by way of limitation, irregularities 40 may be formed by a non-focused beam laser, such as an excimer laser. In particular, a non-focused laser beam may be used to “scuff” one or more sides of substrate 38 in order to form irregularities 40 on substrate 38. Although irregularities 40 have been described as being formed by a non-focused beam laser, in particular embodiments, irregularities 40 may be formed in any other suitable manner. As an example and not by way of limitation, a chemical etch process may be used to form irregularities 40 on substrate 38. In such an example, the drive electrodes 42 or sense electrodes 36 may be used to form a reticule or mask when curing (such as ultra violet curing) a resist on substrate 38. Once the resist is cured, the substrate may be placed in a chemical bath (such as an acid bath) in order to form irregularities 40. As another example, and not by way of limitation, any suitable device and/or method may be used to form irregularities 40 on one or more sides of substrate 38. Although mechanical stacks 30A and 30B have been described as including irregularities 40 on only substrate 38, in particular embodiments, irregularities 40 may be formed on any particular side of any particular layer of mechanical stacks 30A and 30B. As an example and not by way of limitation, in particular embodiments, irregularities 40 may be included in dielectric layer 46.

Although this disclosure describes particular mechanical stacks with a particular number of particular layers made of particular materials, this disclosure contemplates any suitable mechanical stack with any suitable number of any suitable layers made of any suitable materials. As an example and not by way of limitation, in particular embodiments, a layer of adhesive or dielectric may replace the dielectric layer 46, the second layer of OCA 44, and air gap, with there being no air gap to the display 48. Furthermore, although this disclosure describe particular mechanical stacks having sense electrodes 36 disposed in a pattern on a particular side of substrate 38 and drive electrodes 42 disposed in a pattern on another particular side of substrate 38, this disclosure contemplates any suitable mechanical stack with any configuration of drive and/or sense electrodes. As an example and not by way of limitation, mechanical stacks 30A and 30B may have drive and sense electrodes disposed in a pattern on the same side of substrate 38. As another example and not by way of limitation, mechanical stacks 30A and 30B may have drive electrodes disposed in a pattern on one side of substrate 38 and sense electrodes disposed in a pattern on one side of another substrate. As a further example and not by way of limitation, mechanical stacks 30A and 30B may have a self-capacitance implementation, where electrodes of only a single type may be disposed in a pattern on substrate 38.

FIG. 4 illustrates an example mobile telephone that incorporates a substrate with irregularities. In the example of FIG. 4, example mobile telephone 400 incorporates a touch-sensitive apparatus 412 wrapped around an example display 413. Substrate 402 may include or have attached to it tracking areas, which may include tracks providing drive and sense connections to and from the drive and sense electrodes of touch-sensitive apparatus 412. In particular embodiments, an electrode pattern of touch-sensitive apparatus 412 made from metal-mesh technology with a copper, silver, or other suitable metal mesh, as described above. Substrate 402 may have the electrode pattern disposed on a surface. Substrate 402 (which includes one or more irregularities) and the conductive material of the electrode pattern may be flexible, enabling the conductive material to wrap around the left and right edges of the surface to left-side and right-side surfaces. For sharper edges (e.g., with radii of less than 1 mm), the flexible conductive material of the electrode pattern may be thicker or wider at the sharper edges than at the flat portions of surfaces. In particular embodiments, the electrode pattern may wrap around an edge 403 of example mobile phone 400. In other particular embodiments, touch-sensitive apparatus 412 may be wrapped around a curved surface. The curved surface may be curved in one dimension or in two dimensions. As an example and not by way of limitation, touch-sensitive apparatus 412 may be wrapped over surfaces that are substantially perpendicular to each other or, if there is no substantial distinction between surfaces (such as, for example, a pebble-shaped or curved device), an angle of deviation between the surfaces of 45° or greater. Although this disclosure describes and illustrates a particular use of touch-sensitive apparatus 412 in a particular device, this disclosure contemplates any suitable use of touch-sensitive apparatus 412 in any suitable device.

Example display 413 may be a liquid crystal display (LCD), a light-emitting diode (LED) display, an LED-backlight LCD, or other suitable display and may be visible though cover panel 401 and substrate 402, as well as the electrode pattern disposed on substrate 402. Although this disclosure describes and illustrates a particular display and particular display types, this disclosure contemplates any suitable device display and any suitable display types.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An apparatus comprising:
a substrate having a first surface and a second surface opposite the first surface, wherein at least a portion of the first surface includes a plurality of irregularities; and
a touch sensor disposed on the substrate, the touch sensor comprising drive or sense electrodes

2. The apparatus of claim 1, wherein one or more portions of the touch sensor are made of conductive material comprising a conductive mesh.

3. The apparatus of claim 2, wherein the conductive mesh is made from one of carbon nanotubes, copper, silver, a copper-based material, or a silver-based material.

4. The apparatus of claim 1, wherein the touch sensor comprises:
a single-layer configuration with drive and sense electrodes disposed only on the first surface of the substrate; or
a two-layer configuration with drive electrodes disposed on the first surface of the substrate and sense electrodes disposed on the second surface of the substrate.

5. The apparatus of claim 1, wherein the touch sensor comprises:
a single-layer configuration with drive and sense electrodes disposed only on the second surface of the substrate; or
a two-layer configuration with drive electrodes disposed on the second surface of the substrate and sense electrodes disposed on the first surface of the substrate.

6. The apparatus of claim 1, wherein the touch sensor is a mutual-capacitance touch sensor or a self-capacitance touch sensor.

7. The apparatus of claim 1, wherein an excimer laser created the plurality of irregularities.

8. The apparatus of claim 1, wherein the plurality of irregularities are configured to diffuse light.

9. The apparatus of claim 1, wherein the substrate is a substantially flexible substrate.

10. The apparatus of claim 9, wherein the touch sensor further comprises tracking disposed on the substantially flexible substrate configured to provide drive or sense connections to or from the drive or sense electrodes and configured to bend with the substantially flexible substrate.

11. A device comprising:
a substrate having a first surface and a second surface opposite the first surface, wherein at least a portion of the first surface includes a plurality of irregularities;
a touch sensor disposed on the substrate, the touch sensor comprising drive or sense electrodes; and
one or more computer-readable non-transitory storage media embodying logic that is configured when executed to control the touch sensor.

12. The device of claim 11, wherein one or more portions of the touch sensor are made of conductive material comprising a conductive mesh.

13. The device of claim 12, wherein the conductive mesh is made from one of carbon nanotubes, copper, silver, a copper-based material, or a silver-based material.

14. The device of claim 11, wherein the touch sensor comprises:
a single-layer configuration with drive and sense electrodes disposed only on the first surface of the substrate; or
a two-layer configuration with drive electrodes disposed on the first surface of the substrate and sense electrodes disposed on the second surface of the substrate.

15. The device of claim 11, wherein the touch sensor comprises:
a single-layer configuration with drive and sense electrodes disposed only on the second surface of the substrate; or
a two-layer configuration with drive electrodes disposed on the second surface of the substrate and sense electrodes disposed on the first surface of the substrate.

16. The device of claim 11, wherein the touch sensor is a mutual-capacitance touch sensor or a self-capacitance touch sensor.

17. The device of claim 11, wherein an excimer laser created the plurality of irregularities.

18. The device of claim 11, wherein the plurality of irregularities are configured to diffuse light.

19. The device of claim 11, wherein the substrate is a substantially flexible substrate.

20. The device of claim 19, wherein the touch sensor further comprises tracking disposed on the substantially flexible substrate configured to provide drive or sense connections to or from the drive or sense electrodes and configured to bend with the substantially flexible substrate.
